(19) United States
(12) Patent Application Publication
(10) Pub. No.: US 2017/0121204 A1
(43) Pub. Date: May 4, 2017

(54) SEWAGE TREATMENT MONITORING SYSTEM

(71) Applicant: Fenri Development Engineering Co., Ltd., New Taipei City (TW)

(72) Inventors: Wu-Jeng Li, Tainan City (TW); Yung-Yun Cheng, New Taipei City (TW)

(21) Appl. No.: 15/136,489

(22) Filed: Apr. 22, 2016

(30) Foreign Application Priority Data
Oct. 29, 2015 (TW) 104135516

(51) Int. Cl. C02F 11/00

(52) U.S. Cl. CPC C02F 11/00; C02F 2209/003; C02F 2209/42

(57) ABSTRACT

A sewage treatment monitoring system is provided, which includes a sewage treatment system and a cloud monitoring platform. The sewage treatment system includes a plurality of sewage treatment units. A water level detector, an apparatus data detector and a water quality detector are disposed so as to monitor the water level data, the operation status data and the water quality data of the sewage treatment unit. The real time monitoring data are uploaded to a database of the cloud monitoring platform. The real time monitoring data are compared to the threshold value of water level, the exceptional conditions of the apparatus and the continuous water quality monitoring data stored in a wisdom database, so as to determine whether an abnormality occurs in the sewage treatment system. An abnormal message is sent to the operator to conduct the appropriate treatment or adjustment.

### CROSS-REFERENCE TO RELATED APPLICATION

This application claims priority from Taiwan Patent Application No. 104135516, filed on Oct. 29, 2015, in the Taiwan Intellectual Property Office, the content of which is hereby incorporated by reference in their entirety for all purposes.

### BACKGROUND OF THE INVENTION

1. Field of the Invention

This application relates to a sewage treatment monitoring system, and more particularly, to a sewage treatment monitoring system, which is a smart monitoring system, utilizing a detecting apparatus to synchronously monitor the operation of a sewage treatment system and to compare the received data with that storage in the cloud monitoring platform so as to determine whether the sewage treatment system is abnormal.

2. Description of the Related Art

Most of the conventional sewage treatment systems have the treatment procedures such as blocking trash, stilling the sewage to settle impurities, oxidizing and decomposing or feeding agent to disinfect, and so on. When the industrial or domestic sewage is treated, it is discharged to outside to avoid the contaminant or bacteria in the sewage polluting the water resource. The sewage treatment procedure varies with the different kinds of sewage. For example, the industrial sewage has residues containing heavy metallic materials or poisonous substances. As to the domestic sewage, there are organic substances left to be decomposed. However, either industrial sewage treatment or the domestic sewage treatment influences the discharged water quality. The conventional sewage treatment system detects the related apparatus or the sewage accommodating pond in a specific time, or detects the water quality in the discharge pipeline regularly to ensure the discharge standard. Such monitoring mode is not instant. If the water quality has occurred abnormality, it is too late to do the response measure as the sewage has been discharged before the detection and the water pollution has been inevitably caused.

In addition, the resource allocation of the manpower and the cost should be considered, so that it is hard to deploy the specific operation personal in each sewage treatment system for monitoring the system continuously. Usually, the operation personnel do the relevant adjustments after the abnormality has occurred, and whether the response measure is made appropriately, it depends on personal experience. Once the operator fails to confirm if the detection is correctly and reliably, or the dosage is fed excessively in order to meet the discharge standard, it damages to the water resource. As a consequence, the conventional sewage treatment system has shortcomings.

In conclusion, the inventor has been mulling over the aforementioned technical problems and therefore designs a sewage treatment monitoring system which is capable of instantaneously and continuously monitoring the operation status of a sewage treatment system in various sewage treatment procedures. In addition, the provided sewage treatment monitoring system also enables to promote the operation efficiency to avoid the unnecessary manpower consumption and cost, thereby to improve the current shortcomings so as to promote the industrial practicability.

### SUMMARY OF THE INVENTION

In view of the foregoing technical problems, one objective of the present disclosure provides sewage treatment monitoring system to resolve the conventional sewage treatment monitoring system which fails to monitor instantaneously and is incapable of comparing the known data with the detect data to perceive an abnormality occurred in the sewage treatment monitoring system.

In accordance with the objective of the present disclosure, a sewage treatment monitoring system is provided. The sewage treatment monitoring system includes a sewage treatment system and a cloud monitoring platform. The sewage treatment system includes a plurality of sewage treatment units, a water level detector, an apparatus data detector, and a water quality detector. The plurality of sewage treatment units are respectively disposed with a sewage accommodating space, and sewage accommodating spaces are respectively connected by a sewage pipe. when sewage flows into the sewage treatment system through an inlet pipeline, a sewage treatment apparatus corresponding to the sewage accommodating space treats the sewage by a sewage treatment procedure and discharges through a discharge pipeline. The water level detector is disposed in the sewage accommodating space to monitor water level data of the sewage in the sewage accommodating space. The apparatus data detector is connected to the sewage treatment apparatus to monitor operation status data of the sewage treatment apparatus. The water quality detector is disposed in the plurality of sewage treatment units to detect a water quality monitoring data of the sewage in the sewage accommodating space. The cloud monitoring platform is connected to the sewage treatment system through Internet and includes a database, a wisdom database, and a processor. The database stores the water level data, the operation status data and the water quality monitoring data respectively uploaded by the water level detector, the apparatus data detector and the water quality detector. The wisdom database is connected to the database to store a continuous water quality monitoring data derived from historical data of the sewage treatment system, and to store a threshold value of water level and exceptional conditions set by a user. The processor is connected to the database and the wisdom database instantaneously compares the water level data with the threshold value of water level, the operation status data with the exceptional conditions, and the water quality monitoring data with the continuous water quality monitoring data, and when an abnormality occurs in the sewage treatment system, an abnormal message is sent to operation personnel.

Preferably, the sewage accommodating space includes a sewage treatment pond, a sewage storage tank or a sewage canal.

Preferably, the sewage treatment system further includes a monitoring data collector connecting to the water level detector, the apparatus data detector and the water quality detector through the Internet of Things (IoT) for receiving the water level data, the operation status data and the water quality monitoring data, and each data is uploaded to the database through the Internet.

Preferably, the water monitoring data includes temperature, conductivity, pH value, dissolved oxygen, and total suspended particles.

Preferably, the continuous water quality monitoring data continuously records the water quality monitoring data detected by the water quality detector according to a time period, excludes invalid data and lost data and stores the water quality monitoring data in the wisdom database.

Preferably, the processor compares the water quality monitoring data with the continuous water quality monitoring data to obtain a difference value, and evaluates whether an abnormality occurs in the sewage treatment system according to variations of the difference value.

Preferably, the sewage treatment monitoring system includes a plurality of sludge treatment units respectively disposed with a sludge accommodating space. The sludge accommodating spaces are connected by a sludge pipeline. A sludge treatment apparatus disposed in the sludge accommodating space performs a sludge treatment procedure to a sludge produced by the sewage treatment unit, and after the sludge treatment procedure, a waste sludge is discarded, and a waste water generated from the sludge treatment procedure flows back to the sewage treatment system to perform the sewage treatment procedure.

Preferably, the water level detector is disposed in the sludge accommodating space and monitors the water level data of the sludge accommodating space containing the sludge, and then uploads the water level data to the database.

Preferably, the sludge treatment apparatus is disposed with the apparatus data detector, and monitors the operation status data of the sludge treatment apparatus, and then uploads the operation status data to the database.

Preferably, the cloud monitoring platform further includes a control command database, when a comparison result indicates an abnormality occurring in the sewage treatment system, the processor transmits a control command stored in the control command database to the sewage treatment system to directly adjust an operation parameter of the sewage treatment apparatus so as to adjust the operation status of the sewage treatment apparatus.

As mentioned previously, a sewage treatment monitoring system of the present disclosure may have one or more advantages as follows.

1. The sewage treatment system applies the water level detector, the apparatus data detector and the water quality detector to instantaneously monitor the treatment procedure. In addition, the detected data is uploaded to the cloud monitoring platform to enable the user to instantaneously monitor the sewage treatment system so as to reduce the risk of abnormality, thereby to promote the treatment efficiency.

2. The sewage treatment system applies the real time monitoring data with the threshold value of water level, the exceptional conditions of the apparatus and the continuous water quality monitoring data stored in the wisdom database to determine whether an abnormality occurs in the sewage treatment system. Consequently, an abnormal message is transmitted to the operation personnel to conduct the appropriate treatment or adjustment.

3. When an abnormality occurs, the sewage treatment system applies the control command to directly adjust the parameter of the sewage treatment apparatus to simultaneously resolve the abnormal. Hence, it can avoid the unnecessary adjustment, causing waste of manpower and the other sources.

### BRIEF DESCRIPTION OF THE DRAWINGS

FIG. 1 is a schematic diagram of a sewage treatment monitoring system of the present disclosure.

FIG. 2 is a schematic diagram of an embodiment of a sewage treatment monitoring system of the present disclosure.

FIG. 3 is a schematic diagram of an embodiment of a water quality detector of the present disclosure.

### DETAILED DESCRIPTION OF THE PREFERRED EMBODIMENTS

Hereinafter, embodiments of the present invention will be described in detail with reference to the accompanying drawings so that those skilled in the art to which the present invention pertains can realize the present invention. As those skilled in the art would realize, the described embodiments may be modified in various different ways, all without departing from the spirit or scope of the present invention.

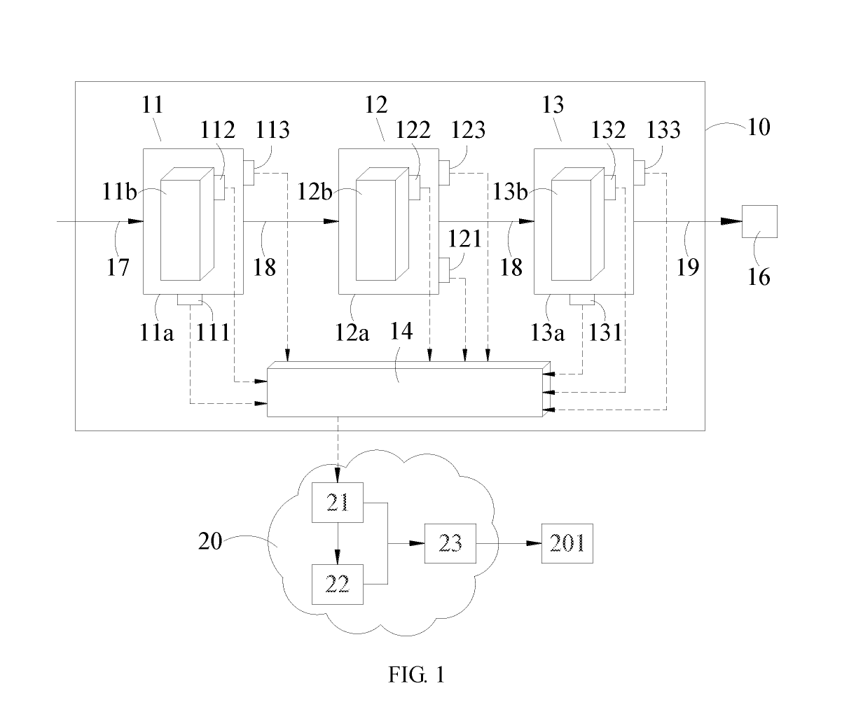

Please refer to FIG. 1, which a schematic diagram of a sewage treatment monitoring system of the present disclosure. As shown in the figure, a sewage treatment monitoring system includes a sewage treatment system 10 and a cloud monitoring platform 20, and the sewage treatment system 10 and the cloud monitoring platform 20 are connected with each other by cable or wireless internet. The sewage treatment system 10 may be a large sewage treatment plant in regions, a small sewage treatment plant in communities, factory's sewage treatment apparatuses, and so on. A single sewage treatment system 10 is applied to be an exemplary embodiment. The cloud monitoring platform 20 of the sewage treatment monitoring system can connect with numerous sewage treatment systems to instantaneously monitor. The sewage flows from an inflow port 15 through an inlet pipeline 17 and is discharged to an outlet 16 through a discharge pipeline 19 after being processed. The sewage treatment system 10 is disposed with a first sewage treatment unit 11, a second sewage treatment unit 12 and a third sewage treatment unit 13. Each sewage treatment unit performs different sewage treatment procedures such as filtering or precipitating impurities in sewage, oxidizing and decomposing organic substances, and adding disinfectant, and so on. The sewage treatment procedure includes disposing respective sewage accommodating spaces. When the sewage flows into one of the sewage accommodating spaces, the sewage treatment produce corresponding to the sewage accommodating space where in the sewage flows into is performed thereto. As shown in the present embodiment, the first sewage treatment unit 11 includes a first sewage accommodating space 11a and a first sewage treatment apparatus 11b. The second sewage treatment unit 12 includes a second sewage accommodating space 12a and a second sewage treatment apparatus 12b. The third sewage treatment unit 13 includes a third sewage accommodating space 13a and a third sewage treatment apparatus 13b. The sewage accommodating spaces are connected by a sewage pipeline 18. Each of the sewage accommodating spaces mentioned herein includes a sewage treatment pond, a sewage storage tank or a sewage canal, and an amount thereof can be disposed based on the actual requirement. Hence, an amount of the sewage treatment unit varies with the actual requirement, and is not limited to three sewage treatment units applied in the present embodiment.

Each of the sewage treatment units of the sewage treatment system 10 is disposed with the relevant detector to monitor the sewage treatment. Please refer to FIG. 1 again. The first sewage treatment unit 11 includes a first water level detector 111, a first apparatus data detector 112 and a water quality detector 113. The first water level detector 111 and the water quality detector 113 are disposed in the first sewage accommodating space 11a to respectively monitor the water level and water quality with respect to the sewage. The first apparatus data detector 112 is connected to the first sewage treatment apparatus 11b to monitor the operation state of the first sewage treatment apparatus 11b. Similarly, the second sewage treatment unit 12 also includes a second water level detector 121, a second apparatus data detector 112 and a second water quality detector 123. The third sewage treatment unit 13 includes a third water level detector 131, a third apparatus data detector 132 and a third water quality detector 133. The disposition of detector of the other sewage treatment units is the same as the of the first sewage treatment unit 11, but it shall be not limited thereto. The water level detector and water quality detector can be disposed in the predetermined sewage treatment unit to monitor specific treatment procedure. The water level detector and water quality detector are therefore unnecessary to be disposed in each sewage treatment unit. In addition, the apparatus data detector is unnecessary an independent detecting device, it can be a capture device or a transmission device for directly read the operation data or operation state of the apparatus. Afterwards, the data is uploaded to the cloud monitoring platform 20.

The water level data, operation status data and water quality monitoring data respectively detected by the first water level detector 111, the first apparatus data detector 112 and the first water quality detector 113 of the first sewage treatment unit 11 are uploaded to a database 21 of the cloud monitoring platform 20 in a manner of wireless transmission. The wireless transmission mentioned herein means that the monitoring data is transmitted by a wireless transmission device 14. The wireless transmission device 14 can be a wireless network base station, enabling each detector to connect to internet so as to upload the data to the database 21. Alternatively, the wireless transmission device 14 can be a data collector which is connected to the first water level detector 111, the first apparatus data detector 112 and the first water quality detector 113 through the IoT to receive and integrate the monitoring data. Afterwards, the wireless transmission device 14 uploads the data to the database 21. Similarly, the second sewage treatment unit 12 and the third sewage treatment unit 13 also apply the same transmission system.

The database 21 of the cloud monitoring platform 20 stores the water level data, operation status data and water quality monitoring data. A wisdom database 22 is connected to the database 21 to store the historical data detected by each water quality detector to be a continuous water quality monitoring data. The continuous water quality monitoring data includes the continuous data with respect to the water quality monitoring data detected daily, weekly, monthly and quarterly. That is, it includes all the data concerning the water quality monitoring index within a specific time period. If the monitoring occurs abnormality or the monitoring apparatus fails to detect the data correctly due to the equipment failure, it has to exclude the abnormal data. As a consequence, the data can be stored accurately and effectively. The calculation can be referred to the following formula.

$$P = \frac{T - ( {D}_{u} + {D}_{m} )}{T} \times 100 \%$$

Here, P denotes a percentage of valid monitor rate. T is a total time of a specific time period. Dᵤ indicates the invalid data, and Dₘ is the lost data of the detector.

When the continuous water quality monitoring data stored in the wisdom database 22 is conformed validly, a processor 23 of the cloud monitoring platform 20 compares the real time water quality monitoring data detected by the first water quality detector 113 with the continuous water quality monitoring data stored in the wisdom database 22 when the first sewage treatment unit 11 is operating to obtain a correlation. Next, a difference value derived from the comparison is applied to calculate feature values such as average value, standard deviation, confidence coefficient, relative error, relative accuracy, and average difference value, and so on. If the feature values exceed in a predetermined threshold value, it is determined that the water quality of the first sewage treatment unit 11 is abnormal. Consequently, the processor 23 transmits an abnormal message 201 to the operation personnel of the sewage treatment system 10. For example, a text message is transmitted to the operator's handheld device to notify the operator of the abnormality occurred in the first sewage treatment unit 11. In order to avoid the water quality worsening, adequate response measure has to be done. Alternatively, the cloud monitoring platform 20 produces exceptional information to inform the personnel of the platform about the abnormality occurred in water quality, such that response measure can be done immediately.

In addition, the wisdom database 22 also stores the water level threshold value set by the user and the exceptional conditions of the apparatus. When the first water level detector 111 of the first sewage treatment unit 11 detects that the water level of sewage in the first sewage accommodating space 11a is higher than a maximum threshold value or lower than a minimum threshold value, the processor 23 determines that the water level is abnormal, and then an abnormal message is transmitted to warn the operation personnel, such that the operation personnel can increase or reduce the level altitude adequately to avoid the first sewage treatment apparatus 11b being idle or failing to treat excessive water quantity. Besides, the exceptional conditions of apparatus indicate whether operation status of the first sewage treatment apparatus 11b is abnormal. For example, the processor 23 determines whether continuous operation of the first sewage treatment apparatus 11b exceeds in index set in the exceptional conditions. If continuous operation of the first sewage treatment apparatus 11b exceeds in the predetermined time, the operation personnel is notified to examine the apparatus or to replace or restart the apparatus so as to avoid the first sewage treatment apparatus 11b being damaged as the continuous operation. Moreover, the cloud monitoring platform 20 further includes a control command database. If the sewage treatment apparatus has abnormality, control commands are generated to respond different abnormal circumstances. When the processor 23 detects an abnormality occurred, it directly transmits the control command corresponding to the abnormal circumstance to the sewage treatment unit. For example, when the first sewage treatment apparatus 11b has an abnormality, the control command directly corresponding to the abnormality is transmitted to adjust the operation parameter of the first sewage treatment apparatus 11b, facilitating the operation status of the apparatus to avoid the abnormality. The configuration and monitoring method of the cloud monitoring platform 20 mentioned above is also feasible to be applied to the second 12 and the third 13 sewage treatment units, hereby to establish a sewage treatment monitoring system.

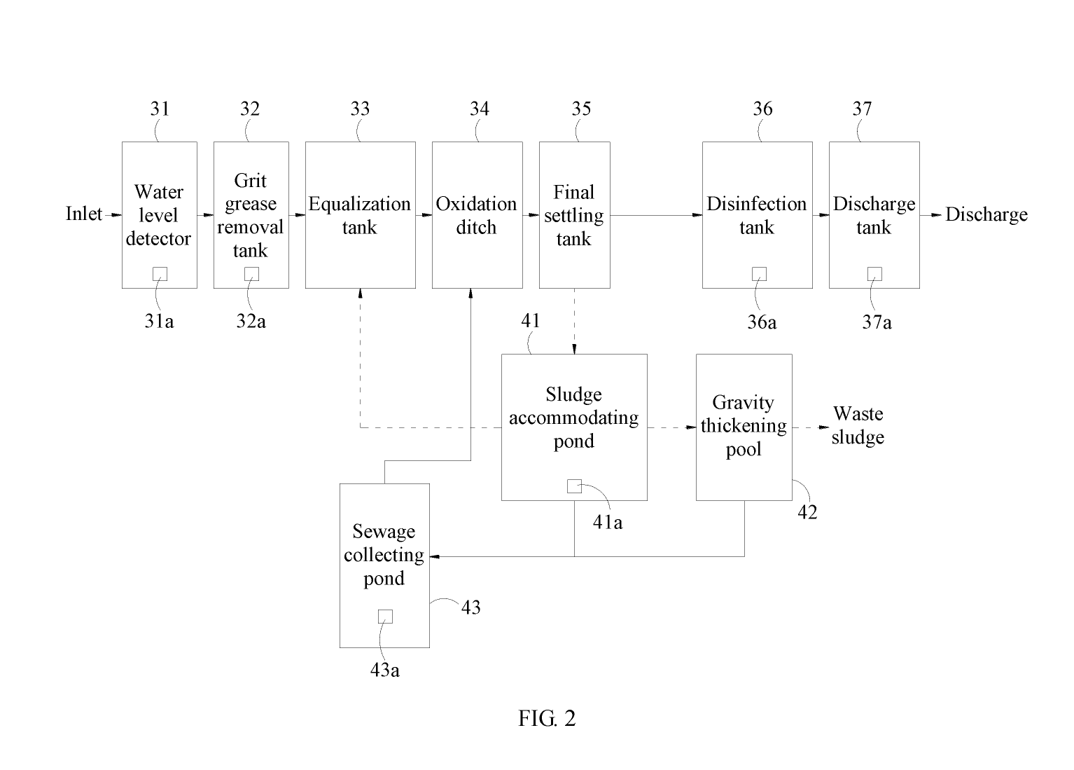

Please refer to FIG. 2, which is a schematic diagram of an embodiment of a sewage treatment monitoring system of the present disclosure. As shown in the figure, the sewage treatment system of the present embodiment includes a plurality of sewage treatment units and a plurality of sludge treatment units. The sewage treatment unit includes a sludge accommodating pond 31, a grit grease removal tank 32, an equalization tank 33, an oxidation ditch 34, a final settling tank 35, a disinfection tank 36 and a discharge tank 37, which are connected by a sewage pipeline. When the sewage flows into the inlet and is treated by the sewage treatment apparatus disposed in the sewage accommodating space, the sewage is discharged from a discharge pipeline. Each of the aforementioned sewage treatment units corresponds to respective sewage treatment apparatuses. For example, the sludge accommodating pond 31 is disposed with a trash rack machine and a conveyor. The grit grease removal tank 32 is disposed with a stirrer, a grit washer, a sand pump, and a sand-washing sewage pump. The equalization tank 33 includes a stirrer and a blower. The oxidation ditch 34 is disposed with an aerator. The final settling tank 35 includes an earth-scraping machine and a scum pump. The disinfection tank 36 is disposed with a suction pump, a feeder, and a deodorizing machine. The discharge tank 37 includes a suction pump. An amount of the aforementioned sewage treatment apparatuses is set based on the scale of the sewage treatment system. Each apparatus can be disposed with an apparatus data detector to instantaneously monitor the operation status of the sewage treatment apparatus. The water level detectors 31a, 32a, 36a, 37a are selectively disposed in the sludge accommodating pond 31, the grit grease removal tank 32, the disinfection tank 36, and the discharge tank 37 to monitor the water level in the sewage treatment procedure.

In addition to the sewage treatment units, the sewage treatment system is further disposed with a plurality of sludge treatment units. The sludge treatment units include a sludge accommodating pond 41, a gravity thickening pool 42 and a sewage collecting pond 43. The sludge generated in the final settling tank 35 is conveyed to a sludge storage tank 41 through sludge pipeline. A part of sludge is thickened to become waste sludge and the reminders are flow back to the equalization tank 33. The sewage produced in the sludge treatment procedure is collected to the sewage collecting pond 43 to be treated again. The sludge accommodating pond 41 of the sludge treatment unit includes a feeding pump, backwash sludge pump, a conveyor, and a dryer. The gravity thickening pool 42 is disposed with a stirrer. The sewage collecting pond 43 is disposed with a suction pump and sewage treatment apparatus. Similar to the sludge treatment units, the sludge treatment units are disposed with an apparatus dada detector to instantaneously monitor the operation status of the sludge treatment apparatus. The water level detectors 41a, 43a are selectively disposed in the sludge accommodating pond 41 and the sewage collecting pond 43 to monitor the water level of the sludge accommodating space in the sewage treatment procedure.

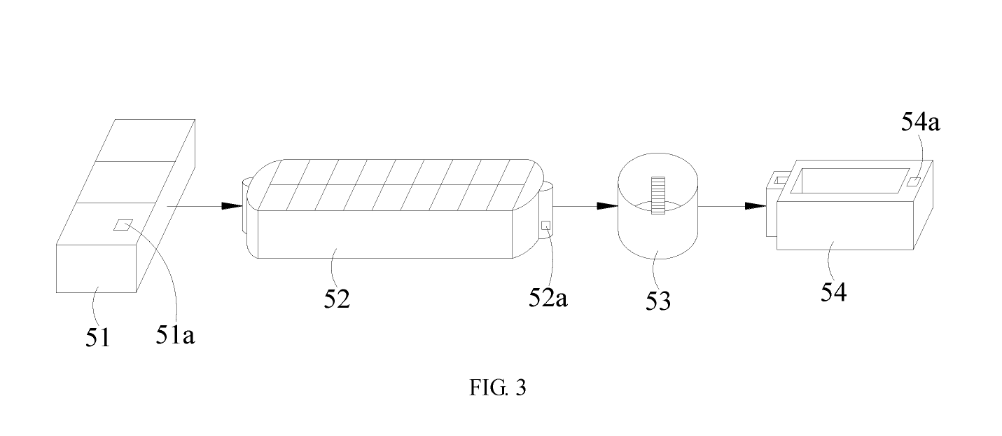

Please refer to FIG. 3, which is a schematic diagram of an embodiment of a water quality detector of the present disclosure. As shown in the figure, the sewage treatment system of the present embodiment include a plurality of sewage treatment units such as a equalization tank 51, an oxidation ditch 52, a settling tank 53 and a discharge tank 54. The arrangement thereof can be referred to the previous embodiment. In addition to monitoring the water level of the sludge accommodating space and the operation status of the sludge treatment apparatus, it has to monitor the water quality of sludge. For example, water quality detectors 51a, 52a, 54a are respectively disposed in the equalization tank 51, the oxidation ditch 52, and the discharge tank 54. By means of the variations of the water quality of sludge in different stages of the sewage treatment procedure, it can determine whether the water quality is normal. The disposition of the water quality detector varies with the sewage treatment system. The water quality detector can be disposed in the other sewage treatment units. It shall not be limited thereto.

The water quality detectors 51a, 52a, 54a detect temperature, conductivity, pH value, dissolved oxygen, and total suspended particles. The water quality detectors detect the monitoring data including different setting conditions of temperature, pH value, and total suspended particles, and so on, and then the obtained monitoring data is uploaded to the database of the cloud monitoring platform. The processor compares the monitoring data instantaneously detected with the continuous water quality monitoring data stored in the wisdom database 22 to obtain a correlation, so as to determine whether each detection item in the treated water quality is normal.

The correlation is determined according to a difference value between the real time water quality monitoring data detected and the continuous water quality monitoring data stored in the wisdom database 22. The difference value is applied to calculate feature values such as average value, standard deviation, confidence coefficient, relative error, relative accuracy, and average difference value, and so on. The calculation can be referred to the following formulae (1)-(5).

$$\begin{matrix}\overline{d} = \frac{1}{n} {\sum }_{i = 1}^{n} {d}_{i} & ( 1 ) \\ Sd = {[ \frac{{\sum }_{i = 1}^{n} {d}_{i}^{2} - \frac{{( {\sum }_{i = 1}^{n} {d}_{i} )}^{2}}{n}}{n - 1} ]}^{\frac{1}{2}} & ( 2 ) \\ CC = {t}_{0.975} \frac{Sd}{\sqrt{n}} & ( 3 ) \\ Relative accuracy = \frac{\vert \overline{d} \vert + \vert CC \vert}{real \text{-} time detecting records average} \times 100 \% & ( 4 ) \\ Average difference value = \frac{1}{n} {\sum }_{i = 1}^{n} \vert {d}_{i} \vert & ( 5 )\end{matrix}$$

Here, d̅ is an arithmetic average value of the difference value between the “instant monitoring record” and “continuous water quality monitoring data”. dᵢ is the difference value between the “instant monitoring record” and “continuous water quality monitoring data”. n is the frequency of monitoring and recording. Sd is the standard deviation of the difference value between the “instant monitoring record” and “continuous water quality monitoring data”. CC is the confidence coefficient. t is the certified value.

The detection of temperature, conductivity, pH value, dissolved oxygen, and total suspended particles of water quality will be described as follows. The temperature detection depends on the disposition of the sewage treatment unit. If an outdoor treatment pond is provided, the temperature detection from morning to night varies with the sunshine duration. For example, the temperatures in the morning and at night are respectively at 26° C. and 23° C., and the wisdom database records the temperature variations daily, weekly and quarterly to establish a temperature variation curve. When the detected temperature data deviates from the curve obviously, an abnormal message is transmitted to the operation personnel. Regarding the conductivity, if the continuous monitoring data with respect to conductivity in a day is maintained between 3.5 μs/cm and 3.9 μs/cm, the lower conductivity reflects a slight contamination level. If the water quality detector detects that the numeral exceeds in the aforementioned numeral or the detected numeral keeps increasing, it is determined that the conductivity is abnormal. As to the detection of pH value, dissolved oxygen, and total suspended particles, they are compared with the continuous monitoring data with respect to pH value, dissolved oxygen, and total suspended particles stored in the wisdom database. For example, the dissolved oxygen is between 2 ppm and 7 ppm, and the pH value is between 8 and 10, and the total suspended particles are between 55 mg/L and 72 mg/L. As a consequence, when the detected monitoring data exceeds in the predetermined threshold value or the difference value keeps increasing, the system is determined occurring an abnormality and an abnormal message is transmitted. In addition to transmitting an abnormal message, the control commands are transmitted to each sewage treatment apparatus according to the predetermined control mode. For example, increasing the dosage to the feeder, increasing the time period for stirring and settling, and so on. When the abnormal data returns to the normal range, the apparatus returns to the original setting accordingly, facilitating the entire sewage treatment system to handle the abnormality more effectively.

While the means of specific embodiments in present invention has been described by reference drawings, numerous modifications and variations could be made thereto by those skilled in the art without departing from the scope and spirit of the invention set forth in the claims. The modifications and variations should in a range limited by the specification of the present invention.

What is claimed is:

1. A sewage treatment monitoring system, comprising:
a sewage treatment system, comprising:
a plurality of sewage treatment units respectively disposed with a sewage accommodating space, and the sewage accommodating spaces respectively connected by a sewage pipe, when sewage flows into the sewage treatment system through an inlet pipeline, a sewage treatment apparatus corresponding to the sewage accommodating space treating the sewage by a sewage treatment procedure and discharging through a discharge pipeline;
a water level detector disposed in the sewage accommodating space monitoring water level data of the sewage in the sewage accommodating space;
an apparatus data detector connected to the sewage treatment apparatus monitoring operation status data of the sewage treatment apparatus;
a water quality detector disposed in the plurality of sewage treatment units detecting water quality monitoring data of the sewage in the sewage accommodating space; and
a cloud monitoring platform connected to the sewage treatment system through Internet, and comprising:
a database storing the water level data, the operation status data and the water quality monitoring data respectively uploaded by the water level detector, the apparatus data detector and the water quality detector;
a wisdom database connected to the database storing a continuous water quality monitoring data derived from historical data of the sewage treatment system, and storing a threshold value of water level and exceptional conditions set by a user; and
a processor connected to the database and the wisdom database instantaneously comparing the water level data with the threshold value of water level, the operation status data with the exceptional conditions, and the water quality monitoring data with the continuous water quality monitoring data, and when an abnormality occurs in the sewage treatment system, an abnormal message sent to operation personnel.

2. The sewage treatment monitoring system of claim 1, wherein the sewage accommodating space comprises a sewage treatment pond, a sewage storage tank or a sewage canal.

3. The sewage treatment monitoring system of claim 1, wherein the sewage treatment system further comprises a monitoring data collector connecting to the water level detector, the apparatus data detector and the water quality detector through the Internet of Things (IoT) for receiving the water level data, the operation status data and the water quality monitoring data, and each data is uploaded to the database through the Internet.

4. The sewage treatment monitoring system of claim 1, wherein the water monitoring data comprises temperature, conductivity, pH value, dissolved oxygen, and total suspended particles.

5. The sewage treatment monitoring system of claim 1, wherein the continuous water quality monitoring data continuously records the water quality monitoring data detected by the water quality detector according to a time period, excludes invalid data and lost data and stores the water quality monitoring data in the wisdom database.

6. The sewage treatment monitoring system of claim 1, wherein the processor compares the water quality monitoring data with the continuous water quality monitoring data to obtain a difference value, and evaluates whether an abnormality occurs in the sewage treatment system according to variations of the difference value.

7. The sewage treatment monitoring system of claim 1, wherein the sewage treatment monitoring system comprises a plurality of sludge treatment units respectively disposed with a sludge accommodating space, and the sludge accommodating spaces are connected by a sludge pipeline, a sludge treatment apparatus disposed in the sludge accommodating space performs a sludge treatment procedure to a sludge produced by the sewage treatment unit, and after the sludge treatment procedure, a waste sludge is discarded, and a waste water generated from the sludge treatment procedure flows back to the sewage treatment system to perform the sewage treatment procedure.

8. The sewage treatment monitoring system of claim 7, wherein the water level detector is disposed in the sludge accommodating space and monitors the water level data of the sludge accommodating space containing the sludge, and then uploads the water level data to the database.

9. The sewage treatment monitoring system of claim 7, wherein the sludge treatment apparatus is disposed with the apparatus data detector, and monitors the operation status data of the sludge treatment apparatus, and then uploads the operation status data to the database.

10. The sewage treatment monitoring system of claim 1, wherein the cloud monitoring platform further comprises a control command database, when a comparison result indicates an abnormality occurring in the sewage treatment system, the processor transmits a control command stored in the control command database to the sewage treatment system to directly adjust an operation parameter of the sewage treatment apparatus so as to adjust the operation status of the sewage treatment apparatus.
